(19) United States
(12) Patent Application Publication
(10) Pub. No.: US 2013/0168222 A1
(43) Pub. Date: Jul. 4, 2013

(54) Conductive Composites

(71) Applicant: Alice Ning, Washington, DC (US)

(72) Inventor: Alice Ning, Washington, DC (US)

(21) Appl. No.: 13/822,009

(22) PCT Filed: Jun. 27, 2012
(86) PCT No.: PCT/US12/44321

§ 371 Date: Mar. 11, 2013

Related U.S. Application Data
(60) Provisional application No. 61/506,184, filed on Jul. 11, 2011.

(51) Int. Cl. H01H 9/02

(52) U.S. Cl. CPC H01H 9/0264
USPC 200/600

(57) ABSTRACT

The invention features a conducting system which when attached to an object, the system converts the object into input device used to input functions on a touch screen device. The system features a material having an active capacitive layer with an antenna design which stores an electrical charge that is substantially similar to a human's body capacitance. Additional layers may be provided for attaching the material and protecting the material.

### RELATED U.S. APPLICATION DATA

This application claims the benefit of provisional application No. 61/506,184, filed Jul. 11, 2011.

### FIELD OF THE INVENTION

The present invention relates, in general, to capacitive materials or composites that can be attached to any object, for example a glove, creating an input device for touch screen devices.

### BACKGROUND OF THE INVENTION

Many electronic devices such as cameras, MP3® players, cell phones, iPod®, for example have a touch screen. A touch screen is a computer display screen that is also an input device. There are a variety of screens which are sensitive to either pressure, light waves, ultrasonic waves, or electric charge. A user interacts with the touch screen device by touching graphics or text on the screen. For example, on a cell phone such as the iPhone®, a user can use the touch screen interface to place a call, answer the phone, play games and surf the internet, to name a few.

With cell phones becoming more popular and having more capabilities, users have become more dependent on them. An input device, such as a stylus, helps to input and retrieve data on electronic devices.

Standard stylus and input devices are inconvenient, oversized, often misplaced and are not precise. Hand coverings or gloves act as an insulator and prevents the capacitive screen from detecting the conductivity of the fingertips through the gloves.

### SUMMARY OF THE INVENTION

The present invention provides a capacitive material having a conductive layer, adhesive layer, and a protective layer forming a conductive device which can be attached to any object or digit creating an input device.

An aspect of an embodiment of the invention provides materials having a capacitive layer and an adhesive layer which can be attached to any object or digit creating an input device.

A further aspect of an embodiment of the invention features a device that is easily installed or attached to an object or digit creating a versatile input device.

A further aspect of an embodiment of the invention features the device being cut-to-fit such that it may be cut in a design or shape and attached to an object or digit.

Additional aspects, objectives, features and advantages of the present invention will become apparent from the following description of the preferred embodiments with reference to the attached drawings.

### BRIEF DESCRIPTION OF THE DRAWINGS

FIG. 1 is an exploded view of an embodiment of the present invention having five layers.

FIG. 2a illustrates a conducting system with a decorative printed design as the outermost layer.

FIG. 2b illustrates a conducting system with the active side as the outermost layer.

FIG. 3 is an exploded view of an alternate embodiment of the present invention having four layers.

FIG. 4 is an exploded view of an alternate embodiment of the present invention showing a material having any shape, size, thickness, and mass.

FIG. 5 is a perspective view of an embodiment of the present invention covering a large portion of the finger surface.

FIG. 6 is a perspective view of an embodiment of the present invention having a ring design attached in a wrap around fashion.

FIG. 7a illustrates the material having a first antenna design.

FIG. 7b illustrates the material having a second antenna design.

FIG. 7c illustrates the material having a third antenna design.

### DETAILED DESCRIPTION OF THE INVENTION

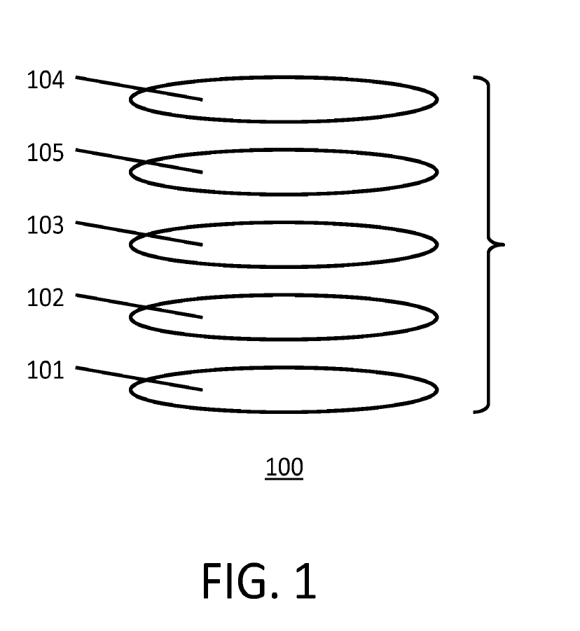

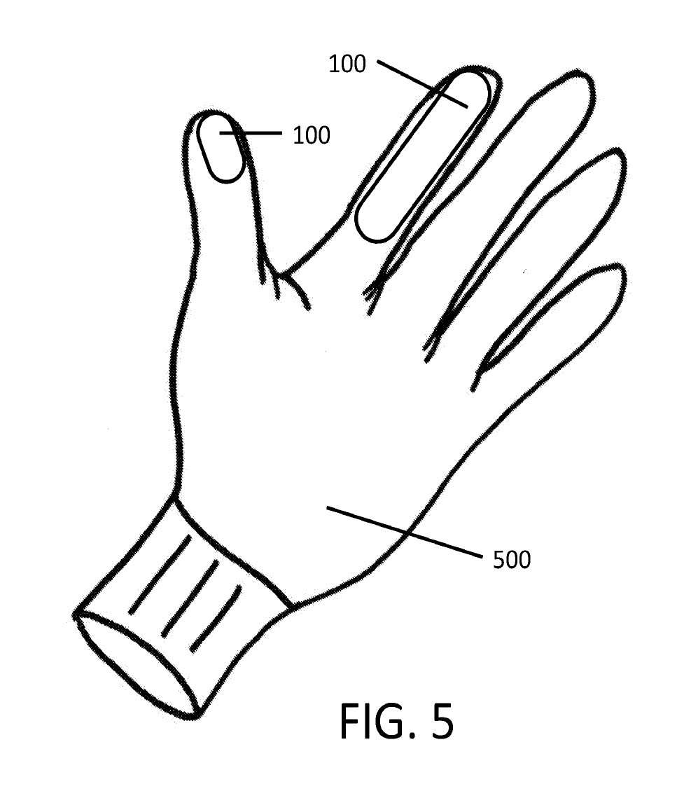

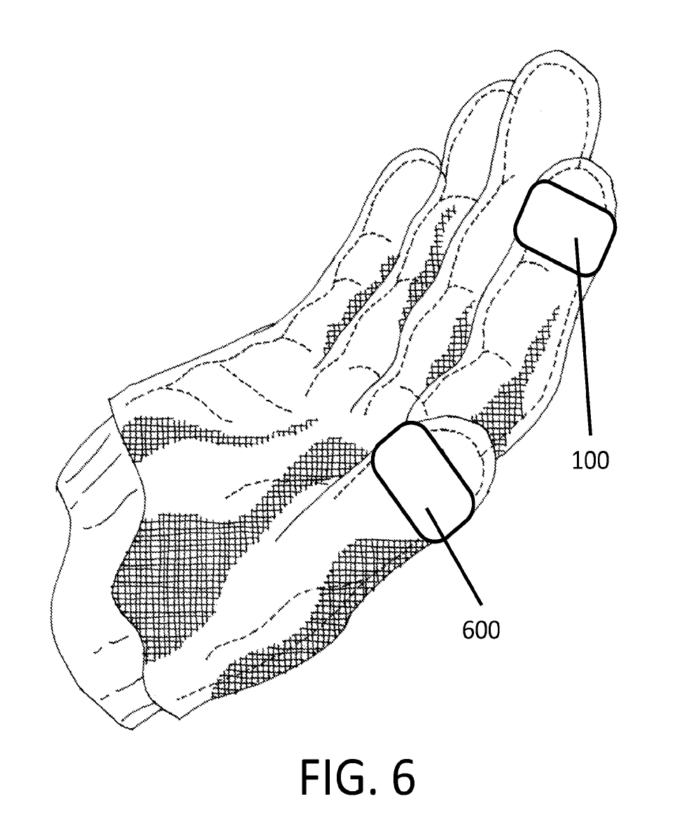

FIG. 1 is an exploded view of an embodiment of the present invention 100 having five layers. The invention features materials layered having conductive features. The composite material is fully flexible, thin, and light-weight. The materials are to be attached to an object or digit allowing the object or digit to act as a “stylus” or input device. The materials can be attached to hand coverings 500 or gloves as shown in FIG. 5 and FIG. 6. The first layer of the conductive composite is an attachment means for affixing the material to an object. The attachment means is an adhesive layer 101 which can be Velcro, high compression plastic, glue, acrylic, rubber, silicone or an alternate attachment means. This layer is attached directly to an object, such as a glove, as shown in FIG. 5 and FIG. 6. The adhesive can adhere to materials such as leather, suede, animal skins, knit, wool, fleece, Goretex, Kevlar, Canvas and clean-lab materials. Adhesives such as DYMO Industrial Permanent Acrylic Adhesive, 3M Rubber Resin, or 3M Silicone Adhesive may be used.

The second layer 102 is an optional base layer that supports the active layer with the active printed capacitor 103. The active layer 103 is positioned between a protective layer 104 and the base layer 102. A decorative layer 105 featuring patterns, shapes or colors may be added to the materials for decorative and aesthetic purposes. The decorative features may be applied to the separate decorative layer or alternatively onto the protective layer 104. A raised surface may be formed underneath the decorative layer 105 to provide a focused point of active input. The point provides a more accurate contact point with the touch interface device. The protective layer 104 is a material that is waterproof, heatproof, colorable and/or can withstand rigid hot and cold temperatures. The protective layer 104 is preferably a conductive tape, such as conductive fabric shielding tape, that is of a thinner design which provides flexibility and durability, high conductivity and shielding effectiveness, peel strength, easy die-cutting and processing. The tape may be constructed of nickel/copper metalized ripstop or plain weave fabric with a pressure sensitive adhesive (PSA), such as High-Flex® made by Laird Technologies.

The base layer 102 is preferably a polyester/Polyurethane tape. The tape is transparent, waterproof, extremely durable and strong, sealable. The tape can withstand temperatures to −40° and is approximately 1 mils thick. The tape is long-lasting but not permanent. Tape such as DYMO Industrial Permanent Polyester Tape, 3M Transparent Polyester tape, or Cleanroom Very High-Tack Tape may be used. The base layer 102 supports the active layer and also protects it as the adhesive layer is applied or the system is used.

The active printed capacitor layer 103 is a capacitive layer formed of a capacitive material. The material is a composite fabric that may or may not be copper-based, such as Flectron® which is made by Laird Technologies. The capacitive material is a material that stores electrical charges. It is formed of highly conductive metals with the flexibility and light weight of fabric to meet a diverse range of EMI/RFI shielding requirements. Flectron is available in copper and nickel/copper woven and nonwoven fabrics that provide outstanding shielding effectiveness and surface conductivity. If the Flectron's surface area is larger than or equal to 4 cm², then the antenna design is not required. In this case, the material can be affixed to an object as act as an input device with a touch device. However, if the surface area is smaller than 4 cm², the antenna design which stores an electrical may be added to the material for it to effectively conduct electricity.

The active layer is a flexible circuit laminate with an antenna design which stores an electrical charge. The active layer 103 is made of a conductive composite structure designed to act as an antenna. Depending on the size and particular design or cuts of the antenna-like composite structure, the device will register at a varying measurement of picofarads. The human body is able to store an electrical charge that varies depending on a number of factors and varies with surroundings such as mass or amount of water, for example. Capacitance is measured in farads. The human body is generally about 22 picofarads. The electrical charge of the active layer 103 measures substantially similar to a human body capacitance. The charge is in a readable range of picofarads and is close to the average measure of the human body's 22 picofarad measurement.

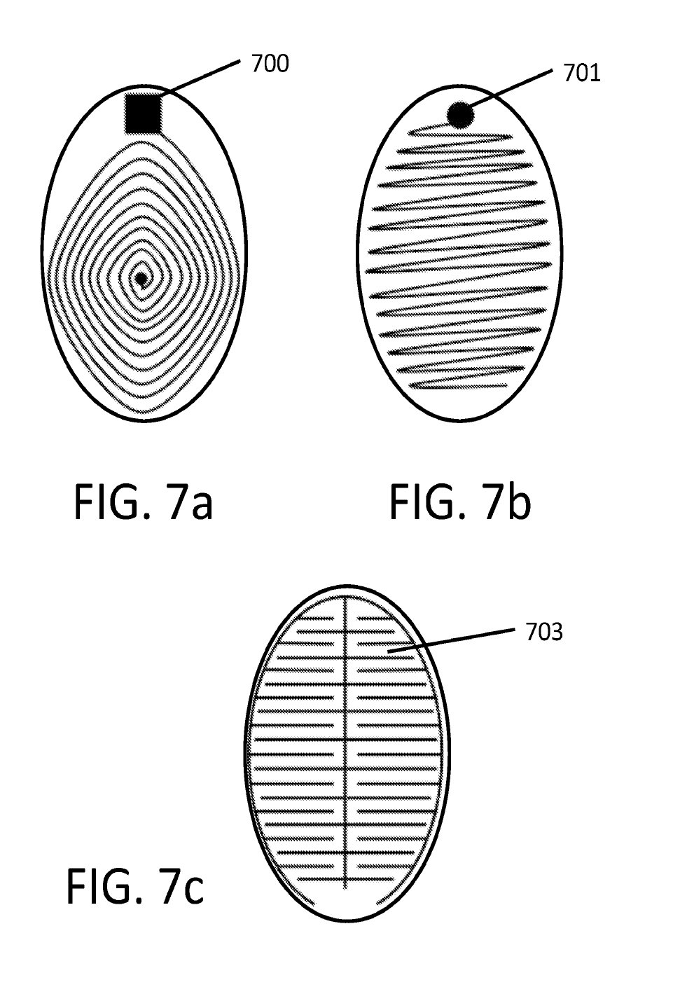

The active layer may alternatively be DuPont™ Pyralux AC flexible circuit materials which are single-sided copper-clad laminates with all-polyimide composite of polyimide film on copper foil. Its physical properties features excellent dimensional stability, Low moisture absorption, High modulus, Excellent thermal resistance, Excellent long term thermal aging, Thermal/humidity resistance, Low CTE and UL 94 recognition: V-0. The surface of the flexible circuit materials features a novel and unique antenna design which is design such that its pattern holds a charge that is substantially similar to the charge of a human body capacitance. Then, the system can mimic the human body's capacitance creating a system which can be added to a device to create an input device. FIG. 7a illustrates the material having a first antenna design 700. FIG. 7b illustrates the material having a second antenna design 701. FIG. 7c illustrates the material having a third antenna design 703. The antenna design may be made up of parallel lines. In certain designs, the lines cannot touch or the antenna effect does not work or is weakened such that the charge is not proper to ensure a reading on a touch sensitive device. Alternate designs having parallel lines that are thinner and closer together allowing for more concentric rings around the center may be created to provide the necessary charge. The protective layer 104 ensures the antenna designs maintain their shape and design and are not damaged. Additionally, the base layer 102 further maintains the shape and design and protects the design.

The antenna design can be etched or printed. For etching, copper is solidified on polyemit film, flexible circuit laminate, and then printed protective film is placed over the pattern. For etching, the protective film is identical to the antenna design in that the protective film has the same pattern, shape and design as the antenna design. Then, it is placed into a highly toxic solution for varying amounts of time so that the copper that is not protected under the patterned film is eaten away by the acid. In a separate embodiment, the antenna design is printed onto the flexible circuit laminate. When printed, the antenna design is printed directly onto the surface of the flexible circuit laminate. Conductive ink may be printed onto the flexible circuit laminate. The ink can be printed in any color, including clear, using conventional methods such as offset, screen print, flexo and gravure and maintain conductivity. For example, T-Ink, Inc. manufactures a conductive ink that may be applied. Decorative layer 105 can also be printed using conductive inks.

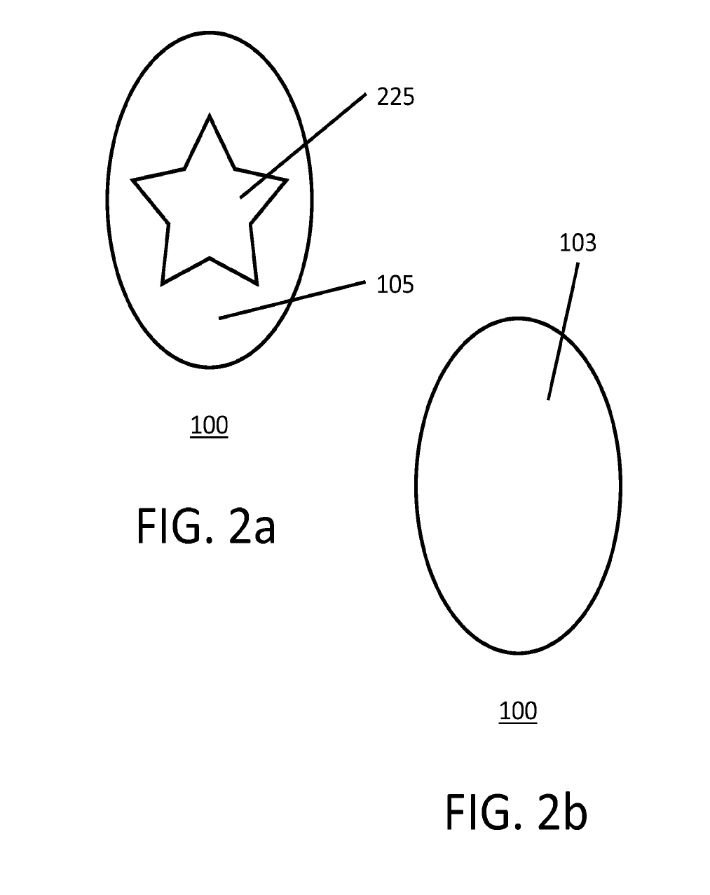

FIG. 2a illustrates a first side of the conducting system 100 with a decorative printed design 225 shown on the aesthetic layer 105 as the outermost layer. The design 225 may be in the style of lightning bolts, hearts, smiley faces, snowflakes or even a clear design. The patterns may be repeating in a colored pattern also. For example, a fingerprint design may be shown on the front side since the capacitive material will be used as an extension to the user's digit or object. Similarly, the composite material may take on any shape, thickness, angle, concavity, convexity, flat, or color or design. The material self-attaches to the fabric of a glove or any object and carries its own level or electrical charge.

In this case, the aesthetic layer 105 will serve as the protective layer to protect and maintain the shape of the antenna design on the active layer 103 and also serve as decoration. In this embodiment, the protective layer 104 is not necessary. FIG. 2b illustrates a conducting system 100 with the active layer 103 as the outermost layer. The outermost layer is the layer that contacts the touch sensing interface so that the system acts as an input device. The radius of the system is about 8 mm to 12 mm and the length of the system is about 10 mm to 14 mm long.

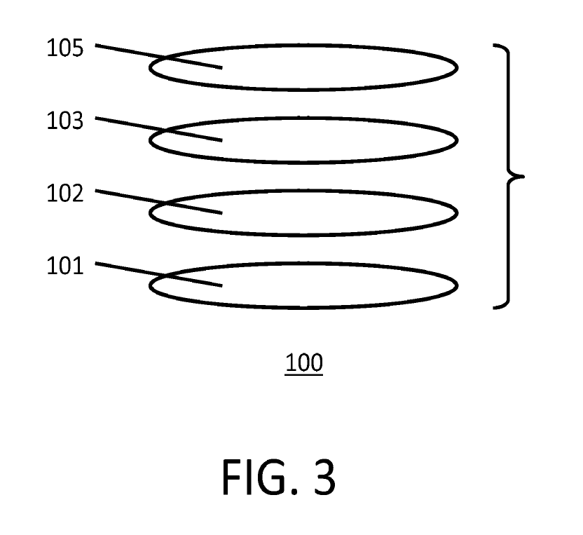

FIG. 3 is an exploded view of an alternate embodiment of the present invention having four layers. The aesthetic layer 105 is the outermost layer providing protecting and decorum. The base layer 102 is provided underneath the aesthetic layer and above the active layer 103. The adhesive layer 101 is beneath the active layer. The adhesive layer 101 can be secured to an object and the object can be converted to an input device by the outermost layer contacting the screen of the touch device. So, an object that normally will not hold a charge and that will not function as an input device because of the lack of charge can now be used as an input device with the attached conducting system 100.

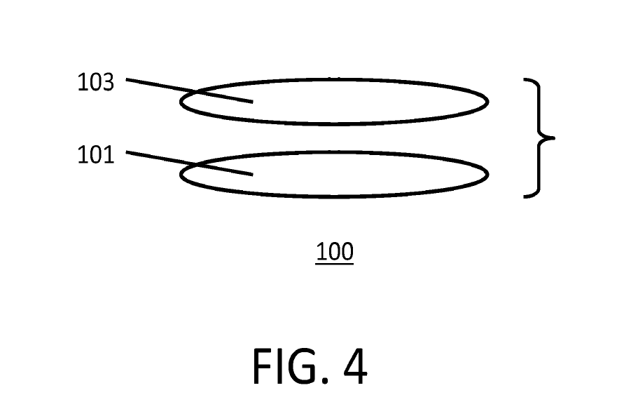

FIG. 4 is an exploded view of an alternate embodiment of the present invention showing a material having any shape, size, thickness, and mass. The active layer 103 may be fused with a coating that protects the antenna design so that the coating and active layer make up one layer of the system. The capacitive material is fused/combined during the manufacturing process with one or more materials to form a single layer that acts as both the protective coating and capacitive material. The capacitive material is attached to the adhesive layer 101. This layer 101 is attached directly to an object, such as a glove, as shown in FIG. 5 and FIG. 6.

FIG. 5 is a perspective view of an embodiment of the present invention 100 covering a large portion of the finger surface of a glove 500. This design provides a larger area that can contact the device so that the glove 500 can be used as an input device where the system 100 is attached. The system 100 may be cut to extend the length of a person's finger. Alternatively, the system 100 may be cut to cover the fingerprint area of a person's finger as shown in FIG. 5 where the thumb is shown. FIG. 6 is a perspective view of an embodiment of the present invention having a ring design 600 attached in a wrap around fashion, such that a top portion of the object is covered by the composite material 100. For example, if attached to a glove, the portion of the glove that covers the nail portion of the digit will also be conductive since the composite material contacts the top portion of the glove. The material does not require an adhesive layer since it can be slid on and off like a ring using the band 600.

In an alternate embodiment of the present invention, the adhesive, capacitive material, base layer and protective coating can be combined to form one layer that attaches to an object where a top layer of the material will contact a touch screen electronic device.

The invention has been described in detail with particular reference to certain preferred embodiments thereof, but it will be understood that variations and modifications can be effected within the spirit and scope of the invention.

1. A conducting system comprising:
a material having an active capacitive layer with an antenna design which stores an electrical charge;
at least one protective layer that protects the antenna design;
and attachment means for affixing the material to an object, wherein the object provides input to a touch-sensing interface.

2. The conducting system of claim 1, wherein the electrical charge is substantially similar to a human body capacitance.

3. The conducting system of claim 1, wherein the antenna design is etched onto the active capacitive layer.

4. The conducting system of claim 3, wherein the active layer comprises a film which is identical to the antenna design, whereby the film is positioned over the antenna design.

5. The conducting system of claim 1, wherein the antenna design is printed onto the active capacitive layer.

6. The conducting system of claim 1, further comprising a decorative layer featuring patterns, shapes or colors.

7. The conducting system of claim 5, wherein the antenna design is a conductive ink.

8. A conducting system comprising:
a material having an active capacitive layer with an antenna design which stores an electrical charge;
a protective layer that protects the antenna design;
a base layer that supports the material, wherein the material is between the protective layer and base layer;
and attachment means for affixing the material to an object, wherein the object provides input to a touch-sensing interface.

9. The conducting system of claim 8, wherein the electrical charge is substantially similar to a human body capacitance.

10. The conducting system of claim 8, wherein the antenna design is etched onto the active capacitive layer.

11. The conducting system of claim 8, wherein the antenna design is printed onto the active capacitive layer.

12. The conducting system of claim 8, further comprising a decorative layer featuring patterns, shapes or colors.

13. The conducting system of claim 11, wherein the antenna design is a conductive ink.

14. The conducting system of claim 8, wherein the protective layer is a conductive tape.

15. The conducting system of claim 8, wherein the object is a hand covering.

16. A conducting system comprising:
a capacitive material having an active layer that is electrically conductive;
and an attachment means for affixing the material to an object, wherein the object provides input to a touch-sensing interface.

17. The conducting system of claim 16, wherein the material further comprises an electrical charge that is substantially similar to a human body capacitance.

18. The conducting system of claim 16, wherein the material further comprise an antenna design that is etched or printed onto the flexible circuit laminate.

19. The conducting system of claim 16, further comprising a decorative layer featuring patterns, shapes or colors.
